(19) United States
(12) Patent Application Publication
(10) Pub. No.: US 2025/0153860 A1
(43) Pub. Date: May 15, 2025

(54) METHOD AND SYSTEM FOR MULTI-MODAL HELICOPTER TRANSPORT

(71) Applicant: Bell Textron Inc., Fort Worth, TX (US)

(72) Inventors: Alvin JONES, Arlington, TX (US); Vitthal Vishnuthreeth ARAKERI, Bangalore (IN)

(73) Assignee: Bell Textron Inc., Fort Worth, TX (US)

(21) Appl. No.: 18/507,978

(22) Filed: Nov. 13, 2023

(51) Int. Cl. B64F 1/22; B60P 3/11

(52) U.S. Cl. CPC B64F 1/22; B65D 19/42; B65D 19/44; B60P 3/11

(57) ABSTRACT

An aircraft-transport skid system includes a first outer frame rail, a second outer frame rail, a first lower inner frame rail, a second lower inner frame rail, and a plurality of lateral support rails connecting the first outer frame rail, the second outer frame rail, the first lower inner frame rail, and the second lower inner frame rail. The first outer frame rail, the second outer frame rail, the first lower inner frame rail, and the second lower inner frame rail are parallel to one another;

[symbol]

### CROSS-REFERENCE TO RELATED APPLICATIONS

This patent application incorporates by reference the entire disclosure of U.S. patent application Ser. No. 17/306,652, filed on May 3, 2021.

### TECHNICAL FIELD

The present disclosure relates generally to field of aircraft, and more particularly, but not by way of limitation, to a method and system for multi-model aircraft transport.

### BACKGROUND

This section provides background information to facilitate a better understanding of the various aspects of the disclosure. It should be understood that the statements in this section of this document are to be read in this light and not as admissions of prior art.

Shipment of aircraft such as helicopters via air, land, or sea can be challenging. Securing the aircraft during transport and managing downward-force loads so as to avoid damage to landing gear and other components of the aircraft are problems that have been difficult to solve.

### SUMMARY

An aircraft-transport skid system includes a first outer frame rail, a second outer frame rail, a first lower inner frame rail, a second lower inner frame rail, and a plurality of lateral support rails connecting the first outer frame rail, the second outer frame rail, the first lower inner frame rail, and the second lower inner frame rail. The first outer frame rail, the second outer frame rail, the first lower inner frame rail, and the second lower inner frame rail are parallel to one another.

An aircraft-transport skid system includes a first outer frame rail, a second outer frame rail, a first lower inner frame rail, a second lower inner frame rail, and a plurality of lockout-block clamps. The first outer frame rail, the second outer frame rail, the first lower inner frame rail, and the second lower inner frame rail are parallel to one another. This summary is provided to introduce a selection of concepts that are further described below in the detailed description. This summary is not necessarily intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 illustrates an aircraft-transport skid system;

FIG. 2 illustrates the aircraft-transport skid system of FIG. 1 with four aircraft ground handling mechanisms incorporated therein;

FIG. 3 illustrates in more detail exemplary aircraft transport-jack systems of FIG. 2;

FIG. 4 illustrates the system of FIG. 2 with an aircraft placed thereon in preparation for transport; and

FIG. 5 illustrates the aircraft-transport skid system of FIG. 1 positioned on a conventional trailer.

### DETAILED DESCRIPTION

Various embodiments will now be described more fully with reference to the accompanying drawings. The disclosure may, however, be embodied in many different forms and should not be construed as limited to the embodiments set forth herein.

Shipment of aircraft such as, for example, helicopters, can be challenging. A solution to challenges presented is needed because, for example, during air transport of the aircraft, downward-force loads may be great high enough to cause damage to landing gear or other components of the aircraft. Various embodiments presented herein aim to prevent damage to the landing gear and other components of the aircraft by redistributing the downward-force loads into areas of an air frame of the aircraft that are better suited to accommodate such loads. In a typical embodiment, different methods of transport can be employed, such as air, rail, sea, or truck transport modes.

In a typical embodiment, jack points and nose landing gear are utilized as attachment points to aircraft-transport skid system, since these are portions of a typical aircraft, such as a helicopter, that can withstand downward-force loads often encountered during transport. Some embodiments include features such as detachable wheels for towing the aircraft, inbuilt chain-lock systems, and main-rotor-lockout systems. Multiple attachment points can be provided in order to accommodate different aircraft configurations.

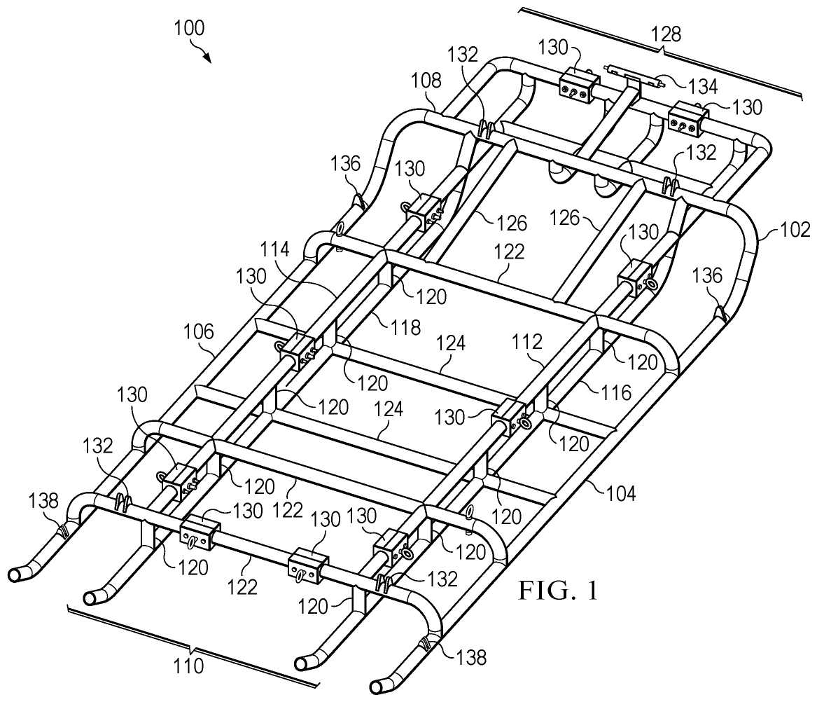

FIG. 1 illustrates an aircraft-transport skid system 100. In a typical embodiment, the aircraft-transport skid system is made primarily of tubular aluminum, although other materials may be utilized as dictated by design objectives. The aircraft-transport skid system 100 includes an outer frame rail system 102, which is illustrated as being formed in a U shape. The outer frame rail system 102 includes a first outer frame rail 104 and a second outer frame rail 106 arranged in parallel with the first outer frame rail 104. The first outer frame rail 104 and the second outer frame rail 106 are arranged so as to run in a generally longitudinal direction relative to an aircraft to be placed on the aircraft-transport skid system 100. Also shown is a transverse connecting frame rail 108 that serves to rigidly connect the first outer frame rail 104 and the second outer frame rail 106 to one another. In the illustrated embodiment, each of the first outer frame rail 104 and the second outer frame rail 106 includes an upwardly curved portion at a front section thereof adjacent to where each connects with the transverse connecting frame rail 108.

The aircraft-transport skid system 100 also includes an inner frame rail system 110. The inner frame rail system 110 includes a first upper inner frame rail 112, a second upper inner frame rail 114, a first lower inner frame rail 116, and a second lower inner frame rail 118. Each of the inner frame rails 112-118 is arranged in parallel with the others of the inner frame rails 112-118. The first upper inner frame rail 112 and the second upper inner frame rail 114 are coplanar. In similar fashion, the first lower inner frame rail 116 and the second lower inner frame rail 118 are coplanar. The first upper inner frame rail 112 is arranged directly above the first lower inner frame rail 116. In similar fashion, the second upper inner frame rail 114 is arranged directly above the second lower inner frame rail 118. A plurality of support posts 120 are arranged perpendicularly to the frame rails 112-118 and provide rigid connections and structural support between respective ones of the upper inner frame rails 112, 114 and the lower inner frame rails 116, 118.

Upper lateral support rails 122 run laterally across the aircraft-transport skid system 100 at a plurality of longitudinal positions and provide structural support and connections between the first outer frame rail 104, the second outer frame rail 106, the first upper inner frame rail 112, and the second upper inner frame rail 114. As shown in FIG. 1, terminal portions of the upper lateral support rails 122 curve downward in order to connect with the first outer frame rail 104 and the second outer frame rail 106.

Also shown are a plurality of lower lateral support rails 124. The lower lateral support rails 124 provide structural support and connections between the first outer frame rail 104, the first lower inner frame rail 116, the second lower inner frame rail 118, and the second outer frame rail 106. Angled nose-support rails 126 are shown connecting and providing structural support between a frontmost one of the upper lateral support rails 122 and the transverse connecting frame rail 108. Forward of the transverse connecting frame rail 108 is a nose-support system 128. The nose-support system 128 includes various frame and support rails that are analogous to those described above.

A plurality of lockout-block clamps 130 are illustrated on various rails of the aircraft-transport skid system 100. The lockout-block clamps 130 are positionable as desired along the various rails on which they are mounted. The lockout-block clamps 130 include one or more eyelets to which straps or chains may be attached. In a typical embodiment, the eyelets are used for tying down the aircraft-transport skid system 100 an aircraft, truck, railcar, or ship. In other embodiments, the eyelets may be used to tie down the aircraft to the aircraft-transport skid system 100 if the aircraft has external tiedown points for such purpose.

A plurality of aircraft mounting brackets 132 are also shown in stationary positions. The aircraft mounting brackets 132 may in some embodiments be positionable. In the embodiment shown, the aircraft mounting brackets 132 include parallel triangular tabs with holes formed therein for insertion of a clevis or bolt to attach the aircraft to the aircraft-transport skid system 100. The aircraft mounting brackets 132 may be positioned and configured in different ways depending upon design considerations. At the front end of the aircraft-transport skid system is shown a nose gear mounting assembly 134 that is adapted to be attached in place of a nose gear assembly of the aircraft that has been removed prior to initiation of mounting the aircraft to the aircraft-transport skid system 100. In various embodiments, the nose gear of the aircraft may or may not be removed before the aircraft is mounted to the aircraft-transport skid system 100. Front ground handling mechanism mounting brackets 136 and rear ground handling mechanism mounting brackets 138 permit ground handling mechanisms to be mounted to the aircraft-transport skid system 100 for transport thereof either with or without an aircraft mounted to the aircraft-transport skid system 100.

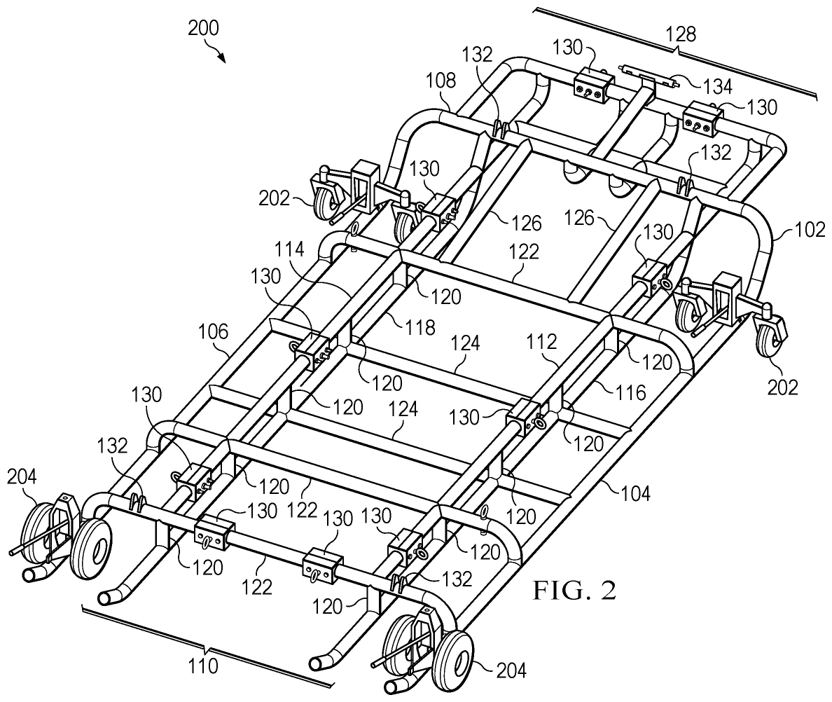

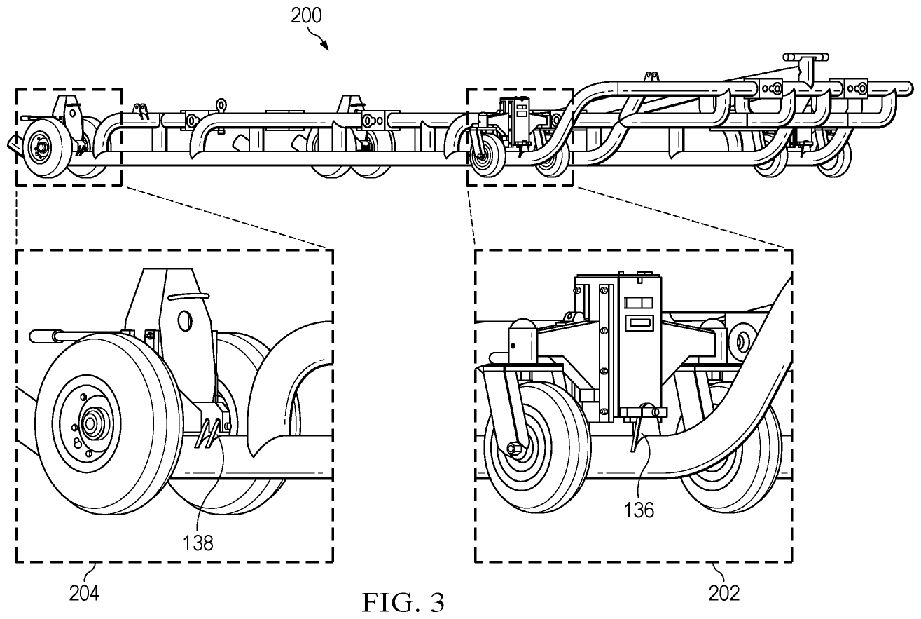

FIG. 2 illustrates an aircraft-transport skid system 200. The aircraft-transport skid system 200 includes the aircraft-transport skid system 100 with four aircraft ground handling mechanisms incorporated therein. Two front aircraft ground handling mechanisms 202 and two rear aircraft ground handling mechanisms 204 are illustrated. The front aircraft ground handling mechanisms 202 are mounted to the aircraft-transport skid system 100 via the front ground handling mechanism mounting brackets 136 and the rear aircraft ground handling mechanisms 204 are mounted to the aircraft-transport skid system 100 via the rear ground handling mechanism mounting brackets 138. The aircraft ground handling mechanisms 202, 204 include jacking mechanisms to raise the aircraft-transport skid system 200 off the ground and also include wheels to permit transport of the aircraft-transport skid system 200 either with or without an aircraft mounted thereto. FIG. 3 illustrates in greater detail the aircraft ground handling mechanisms 202 mounted to the aircraft-transport skid system 100 via the front ground handling mechanism mounting brackets 136 and the rear aircraft ground handling mechanisms 204 mounted to the aircraft-transport skid system 100 via the rear ground handling mechanism mounting brackets 138.

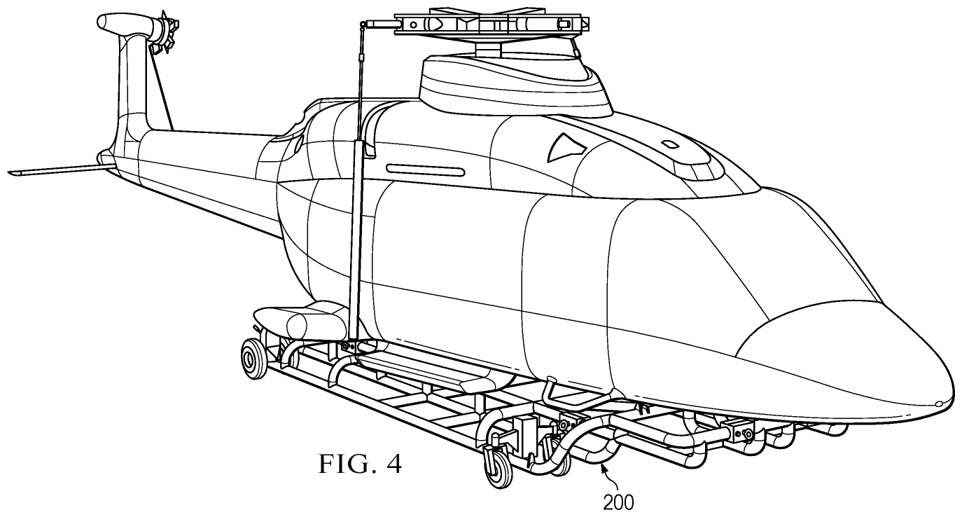

FIG. 4 illustrates the aircraft-transported skid to the aircraft-transport skid system 200 with an aircraft mounted thereto. Those having skill in the art will appreciate that a nose portion of the aircraft is raised by virtue of the angled nose-support rails 126 and the nose-support system 128 being higher than, for example, the upper inner frame rails 114, 118. Raising of the nose portion of the aircraft serves to lower the tail of the aircraft such that, for example, the tail portion is no higher than the rotor hub of the aircraft, which positioning serves to ensure that, if the rotor hub clears an overhead obstruction, the tail portion will as well. Various embodiments can be configured in different ways in order to achieve clearance or other design objectives.

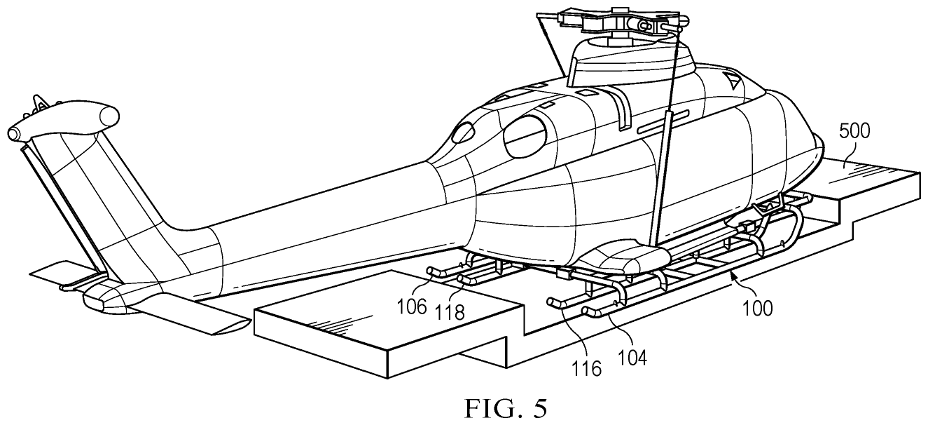

FIG. 5 illustrates an aircraft mounted to the aircraft-transport skid system 100 on the trailer of a semi-trailer truck. As shown in FIG. 5, the first outer frame rail 104 and the second outer frame rail 106 are hanging off the lateral edges of a trailer 500, but the first lower inner frame rail 116 and the second lower inner frame rail 118 are supporting the aircraft. Therefore, in a typical embodiment, an outer with laterally between the first lower inner frame rail 116 and the second lower inner frame rail 118 is less than 8.5 feet in order to accommodate standard dimensions of trailers of semi-trailer trucks. Those having skill in the art will appreciate that having all four of the rails 104, 106, 116, and 118 supporting an aircraft mounted to the aircraft-transport skid system 100 provides greater stability during transport via, for example, air, rail, or sea.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. An aircraft-transport skid system comprising:
a first outer frame rail;
a second outer frame rail;
a first lower inner frame rail;
a second lower inner frame rail; and
a plurality of lateral support rails connecting the first outer frame rail, the second outer frame rail, the first lower inner frame rail, and the second lower inner frame rail;
wherein the first outer frame rail, the second outer frame rail, the first lower inner frame rail, and the second lower inner frame rail are parallel to one another.

2. The aircraft-transport skid system of claim 1, comprising a plurality of aircraft mounting brackets.

3. The aircraft-transport skid system of claim 1, comprising a plurality of lockout-block clamps.

4. The aircraft-transport skid system of claim 3, comprising:
a first upper inner frame rail parallel to and directly above the first lower inner frame rail; and
a second upper inner frame rail parallel to and directly above the second lower inner frame rail;
wherein each of the plurality of lockout-block clamps is coupled to one of the first upper inner frame rail, the second upper inner frame rail, the first outer frame rail, and the second outer frame rail.

5. The aircraft-transport skid system of claim 3, wherein each of the plurality of lockout-block clamps is positionable.

6. The aircraft-transport skid system of claim 1, comprising a plurality of ground handling mechanism mounting brackets.

7. The aircraft-transport skid system of claim 6, wherein each of the plurality of ground handling mechanism mounting brackets is mounted to one of the first outer frame rail and the second outer frame rail.

8. The aircraft-transport skid system of claim 4, comprising a plurality of aircraft mounting brackets.

9. The aircraft-transport skid system of claim 8, wherein each of the plurality of aircraft mounting brackets is connected to one of the first upper inner frame rail and the second upper inner frame rail.

10. The aircraft-transport skid system of claim 1, comprising a nose gear mounting assembly adapted to mount to an aircraft in place of a nose gear of the aircraft that has been removed from the aircraft.

11. An aircraft-transport skid system comprising:
a first outer frame rail;
a second outer frame rail;
a first lower inner frame rail;
a second lower inner frame rail; and
a plurality of lockout-block clamps;
wherein the first outer frame rail, the second outer frame rail, the first lower inner frame rail, and the second lower inner frame rail are parallel to one another.

12. The aircraft-transport skid system of claim 11, comprising:
a plurality of lateral support rails connecting the first outer frame rail and the second outer frame rail; and
a plurality of aircraft mounting brackets, each of the plurality of aircraft mounting brackets connected to one of the plurality of lateral support rails.

13. The aircraft-transport skid system of claim 11, comprising:
a plurality of detachable ground handling mechanisms;
wherein each of the plurality of detachable ground handling mechanisms is coupled to one of the first outer frame rail and the second outer frame rail.

14. The aircraft-transport skid system of claim 13, comprising:
a first upper inner frame rail parallel to and directly above the first lower inner frame rail; and
a second upper inner frame rail parallel to and directly above the second lower inner frame rail;
wherein each of the plurality of lockout-block clamps is coupled to one of the first upper inner frame rail, the second upper inner frame rail, the first outer frame rail, and the second outer frame rail.

15. The aircraft-transport skid system of claim 13, wherein each of the plurality of lockout-block clamps is positionable.

16. The aircraft-transport skid system of claim 11, comprising a plurality of ground handling mechanism mounting brackets.

17. The aircraft-transport skid system of claim 16, wherein each of the plurality of ground handling mechanism mounting brackets is mounted to one of the first outer frame rail and the second outer frame rail.

18. The aircraft-transport skid system of claim 14, comprising:
a plurality of aircraft mounting brackets;
wherein each of the plurality of aircraft mounting brackets is connected to one of the first upper inner frame rail and the second upper inner frame rail.

19. The aircraft-transport skid system of claim 11, comprising a nose gear mounting assembly adapted to mount to an aircraft in place of a nose gear of the aircraft that has been removed from the aircraft.

20. The aircraft-transport skid system of claim 11, comprising a plurality of detachable ground handling mechanisms.
